(19) United States
(12) Patent Application Publication
(10) Pub. No.: US 2016/0250894 A1
(43) Pub. Date: Sep. 1, 2016

(54) Crown Reinforcement For Aircraft Tire

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Marc ROMERO DE LA OSA, Clermont-Ferrand Cedex 9 (FR); Serge DELACROIX, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/029,965

(22) PCT Filed: Oct. 29, 2014
(86) PCT No.: PCT/EP2014/073190

§ 371 Date: Apr. 15, 2016

(30) Foreign Application Priority Data
Oct. 30, 2013 (FR) 1360603

(51) Int. Cl. B60C 9/20; B60C 11/00; B60C 9/00; B60C 9/02; B29D 30/70; B29D 30/30

(52) U.S. Cl. CPC B60C 9/2003; B29D 30/70; B29D 30/3035; B60C 9/0042; B60C 9/005; B60C 9/2009; B60C 9/02; B60C 11/00; B60C 2009/2035; B29D 2030/3078; B60C 2009/2048; B60C 2009/0035

(57) ABSTRACT

Working layer (5) comprises a circumferential zigzag winding of a strip (6) on a cylindrical surface having as its axis the axis of rotation of the tire (1), with a periodic curve (7), the peak-to-peak amplitude of which defines the axial width L of the working layer (5) between a first and a second axial end (I, I′). The working layer (5) is made up, in any meridian plane (YZ) containing the axis of rotation of the tire (1), of an arrangement of portions of strip (6) extending axially from the first axial end (I) to the second axial end (I′) of the working layer (5), such that two consecutive portions of strip (6) overlap, at least in part, over a width of overlap e. The width of overlap e between two consecutive portions of strip (6) is constant over the entire axial width L of the working layer (5).

The present invention relates to an aircraft tire and, in particular, to the crown reinforcement of an aircraft tire.

In general, a tire comprises a tread intended to come into contact with the ground via a tread surface, the tread being connected by two sidewalls to two beads, the two beads being intended to provide a mechanical connection between the tire and a rim on which the tire is mounted.

In what follows, the circumferential, axial and radial directions of the tire respectively denote a direction tangential to the tread surface of the tire in the direction of rotation of the tire, a direction parallel to the axis of rotation of the tire, and a direction perpendicular to the axis of rotation of the tire. “Radially on the inside and, respectively, radially on the outside” mean “closer or, respectively, further away, from the axis of rotation of the tire”. “Axially on the inside or, respectively, axially on the outside” mean “closer to or, respectively, further away from, the equatorial plane of the tire”, the equatorial plane of the tire being the plane that passes through the middle of the tread surface of the tire and is perpendicular to the axis of rotation of the tire.

A radial aircraft tire more particularly comprises a radial carcass reinforcement and a crown reinforcement, both as described, for example, in document EP 1381525.

The radial carcass reinforcement is the tire reinforcing structure that connects the two beads of the tire. The radial carcass reinforcement of an aircraft tire generally comprises at least one carcass layer, each carcass layer being made up of reinforcers, usually textile, coated in a polymeric material of the elastomer or elastomer compound type, the reinforcers being mutually parallel and forming, with the circumferential direction, an angle of between 80° and 100°.

The crown reinforcement is the tire reinforcing structure radially on the inside of the tread and at least partially radially on the outside of the radial carcass reinforcement. The crown reinforcement of an aircraft tire generally comprises at least one crown layer, each crown layer being made up of mutually parallel reinforcers coated in a polymeric material of the elastomer or elastomer compound type. Among the crown layers a distinction is usually made between the working layers, that make up the working reinforcement and are usually made of textile reinforcers, and the protective layers, which make up the protective reinforcement, made of metal or textile reinforcers and arranged radially on the outside of the working reinforcement. The working layers govern the mechanical behaviour of the crown reinforcement. The protective layers essentially protect the working layers from attack likely to spread through the tread radially toward the inside of the tire. A crown layer, and particularly a working layer, is geometrically characterized by its axial width, which means the distance between its axial ends.

The textile reinforcers of the carcass layers and of the crown layers are usually cords made of spun textile filaments, preferably made of aliphatic polyamide or of aromatic polyamide. The mechanical properties under tension (modulus, elongation and breaking force) of textile reinforcers are measured after prior conditioning. “Prior conditioning” means that the textile reinforcers are stored for at least 24 hours, prior to measurement, in a standard atmosphere in accordance with European standard DIN EN 20139 (a temperature of 20±2° C.; a relative humidity of 65±2%). The measurements are taken in the known way using a ZWICK GmbH & Co (Germany) tensile testing machine of type 1435 or type 1445. The textile reinforcers are subjected to tension over an initial length of 400 mm at a nominal rate of 200 mm/min. All of the results are averaged over 10 measurements.

An elastomeric material, such as the one used to coat the reinforcers of the carcass layers and of the crown layers, can be mechanically characterized, after curing, by tensile stress-strain characteristics, determined by tensile testing. This tensile testing is carried out on a test specimen according to a method known to those skilled in the art, for example in accordance with international standard ISO 37 and under normal temperature (23+ or −2° C.) and relative humidity (50+ or −5% relative humidity) conditions defined by international Standard ISO 471. The elastic modulus at 10% elongation of an elastomeric compound, expressed in mega pascals (MPa) is the name given to the tensile stress measured for a 10% elongation of the test specimen.

The composite material made up of the reinforcers coated in an elastomeric compound may also be characterized mechanically by tensile testing carried out on a test specimen of unit width. In particular, the tensile stiffness K and the tensile force at break, or breaking strength R, for a test specimen of composite material of unit width can be measured.

During the manufacture of an aircraft tire and, more specifically, during the step of laying the working reinforcement, a working layer is usually obtained by a zigzag circumferential winding or a circumferential winding in turns of a strip made up of at least one continuous textile reinforcer coated in an elastomeric compound, on the lateral surface of a building drum. Whether produced by a circumferential zigzag winding or by a circumferential winding in turns, the working layer is then made up of the juxtaposition of a width of strip for each turn of winding.

Circumferential zigzag winding means a winding in the circumferential direction of the tire and with a periodic curve, which means to say one formed of periodic waves oscillating between extrema. Winding a strip with a periodic curve means that the midline of the wound strip, defined as being the line equidistant from the edges of the strip, coincides with the periodic curve. The peak-to-peak amplitude between the extrema of the periodic curve thus defines the axial width of the working layer, namely the distance between the axial ends thereof. The period of the periodic curve is usually between 0.5 times and 3 times the circumference of the building drum on which the strip is laid. The periodic curve is also characterized by the angle it forms in the equatorial plane of the tire with the circumferential direction of the tire and by a radius of curvature, at the extrema of the periodic curve. For a conventional zigzag winding, the angle of the periodic curve, which corresponds to the angle formed by the textile reinforcers, one parallel to the next, that make up the strip, is generally between 5° and 35° with respect to the circumferential direction. A circumferential zigzag winding implies that the working layers have to be assembled in pairs, a pair of working layers constituting a working bi-ply. A working bi-ply is made up of two working layers radially superposed in the main section, namely in the portion axially on the inside of the two axial ends of the working bi-ply, and by more than two working layers radially superposed at the axial ends thereof. The additional number of additional working layers in the radial direction, at the axial ends, in comparison with the two working layers in the main section is referred to as the axial end additional thickness. This axial end additional thickness is generated by the crossings of strips at the extrema of the periodic curve. A working reinforcement is thus made up of the radial superposition of several working bi-plys. Such a working reinforcement comprising working layers obtained by circumferential zigzag winding of a strip has been described in documents EP 0540303, EP 0850787, EP 1163120 and EP 1518666.

Circumferential winding in turns means a winding in the circumferential direction of the tire and at a helix of a diameter equal to the diameter of the building drum on which the strip is laid and with a mean angle of between 0° and 5° with respect to the circumferential direction. The working layer thus obtained by winding in turns is said to be circumferential because the angle of the textile reinforcers of the strip, one parallel to the next, that make up the strip, formed in the equatorial plane with the circumferential direction is between 0° and 5°. The principle of circumferential winding in turns leads to the creation of a single working layer rather than a working bi-ply as was obtained with zigzag winding.

In the case of circumferential zigzag winding it is known that the axial end additional thicknesses of the working bi-plys are sensitive to the onset of endurance damage, such as cracks which may evolve into significant degradation of the working reinforcement and, therefore, reduce the life of the tire. These cracks may appear at the internal interfaces of an axial end additional thickness of a working bi-ply or at the interface between the axial end additional thicknesses of two adjacent working bi-plys.

The inventors have set themselves the objective of improving the endurance of the working reinforcement of an aircraft tire, by reducing its sensitivity to the risk of cracking of the axial end additional thicknesses of the working layers.

According to the invention, this objective has been achieved by an aircraft tire comprising:

a working reinforcement radially on the inside of a tread and radially on the outside of a carcass reinforcement,

the working reinforcement comprising at least one working layer made up of a circumferential zigzag winding of a strip on a cylindrical surface having as its axis of revolution the axis of rotation of the tire, with a periodic curve, the peak-to-peak amplitude of which defines the axial width L of the working layer between a first and a second axial end,

the working layer being made up, in any meridian plane containing the axis of rotation of the tire, of an arrangement of portions of strip extending axially from the first axial end to the second axial end of the working layer,

the strip of width W being made up of textile reinforcers coated in an elastomeric compound,

in any meridian plane containing the axis of rotation of the tire, the arrangement of portions of strip extending axially from the first axial end to the second axial end of the working layer being such that two consecutive portions of strip overlap, at least in part, over a width of overlap e, and the width of overlap e between two consecutive portions of strip being constant over the entire axial width L of the working layer.

According to the invention, a working layer is made up of an arrangement of portions of strip extending axially from the first axial end to the second axial end of the working layer, such that two consecutive portions of strip overlap, at least in part, over a width of overlap e. In other words, two consecutive portions of strip are not juxtaposed, as in a conventional working layer of the prior art, but are partially superposed. Such a working layer is referred to as a lapped working layer. In the main section, away from the axial ends, a lapped working layer has a radial thickness equal to 2*W/(W−e) times the thickness of strip, where W is the width of strip and e is the width of overlap, whereas a conventional working bi-ply has a radial thickness equal to twice the thickness of strip. At the axial ends, the portions of strip are arranged in a chevron configuration, which means that the axial end additional thickness of a lapped layer is less than the sum of the axial end additional thicknesses of an equivalent radial stack of bi-plys, thereby reducing the risk of internal cracking at the axial end additional thickness. Moreover, the principle of overlapping makes it possible to increase the thickness of the working layer in the main section compared with a conventional working layer, and therefore makes it possible to reduce the number of working layers that need to be superposed in order to obtain a target breaking strength for the working reinforcement. As a result, the number of interfaces between axial end additional thicknesses of working layers is reduced, thereby reducing the risk of cracking at the interfaces between two consecutive axial end additional thicknesses.

A lapped working layer has a breaking strength equal to W/(W−e) times the breaking strength R of a conventional working layer formed of an axial juxtaposition of portions of strip. Thus a lapped working layer with a width of overlap equal to 0.5 times the width W of the strip has a breaking strength equal to 2R and is therefore equivalent to a working bi-ply. In general, the choice of the width of overlap means that the level of tensile stiffness and breaking strength can be adjusted using just one working layer.

The overlapping of consecutive portions of strip is in effect over the entire width of the lapped working layer, thereby distributing the amount of strip reinforcers more evenly between the main section and the axial end additional thicknesses. In comparison with a conventional working layer, the quantity of reinforcers in the main section, as a result of the overlap, is higher, and so the breaking strength of the working layer in this main section is higher, thereby guaranteeing a better ability to withstand the tire inflation pressure.

Finally, the width of overlap is constant over the entire axial width of the lapped working layer, making it possible to have a breaking strength that is even across the entire axial width of the lapped working layer.

Advantageously, the width of overlap e between two consecutive portions of strip is at least equal to 0.5 times and at most equal to 0.8 times the width W of the strip. An e/W ratio of less than 0.5 does not allow the lapping effect to be significant. An e/W ratio higher than 0.8 implies an angle of inclination of the portions of strip, in any meridian plane, with respect to the axial direction, that is too high thereby making it difficult to control the geometry of the lapped working layer.

According to a first preferred embodiment, the width of overlap e between two consecutive portions of strip is equal to 0.5 times the width W of the strip. This value makes it possible to obtain a lapped working layer equivalent to two working layers or to a working bi-ply, from a breaking strength standpoint, with the advantage of having one fewer interface between portions of strip at the axial end additional thicknesses, and therefore a reduced risk of cracking.

According to a second preferred embodiment, the width of overlap e between two consecutive portions of strip is equal to 0.66 times the width W of the strip. This value makes it possible to obtain a lapped working layer equivalent to three working layers, from a breaking strength standpoint, with the advantage of having two fewer interfaces between portions of strip at the axial end additional thicknesses, and therefore a reduced risk of cracking.

Advantageously, the width W of the strip is at least equal to 2 mm, preferably at least equal to 6 mm A strip generally comprises at least 2 textile reinforcers, the diameter of which is approximately equal to 1 mm, hence giving a minimum strip width of 2 mm. A strip width of less than 2 mm does not allow a significant width of overlap to be achieved between two consecutive portions of strip. A strip width at least equal to 6 mm makes it possible to reduce the building time for creating the lapped working layer, thereby improving productivity.

More advantageously still, the width W of the strip is at most equal to 20 mm, preferably at most equal to 14 mm The higher the width of the strip, the higher the number of interfaces between portions of strip at the axial end additional thicknesses and therefore the greater the risk of cracking. Thus, a width of strip at most equal to 20 mm and preferably at most equal to 14 mm guarantees a good compromise between endurance and productivity.

It is advantageous for the strip to comprise reinforcers made of an aliphatic polyamide. This is because reinforcers made of aliphatic polyamide, such as nylon, are commonly used in the field of aircraft tires because they are relatively light in weight, giving a significant saving on the weight of the tire and therefore allowing a gain in the aircraft payload.

Alternatively, the strip comprises reinforcers made of an aromatic polyamide. Reinforcers made of aromatic polyamide, such as aramide, in fact make it possible to obtain a good compromise between mechanical strength and mass. Reinforcers made of aromatic polyamide make it possible to reduce the mass of the working layer, in comparison with reinforcers made of aliphatic polyamide, for a working layer of given breaking strength.

Another solution is to have a strip comprising reinforcers made of a combination of an aliphatic polyamide and of an aromatic polyamide. Such reinforcers are generally referred to as hybrid reinforcers and offer the technical advantages of nylon and of aramide: mechanical strength, tensile deformability and lightness of weight. Hybrid reinforcers also make it possible to reduce the mass of the working layer, by comparison with reinforcers made of aliphatic polyamide, for a working layer of given breaking strength.

The invention also relates to a method of manufacturing an aircraft tire according to the invention. This method comprises a step of manufacturing a working layer in which step the working layer is obtained by circumferential zigzag winding of a strip of width W onto the lateral surface of a building drum of radius F_{f} and having as axis of revolution the axis of rotation of the tire, with a periodic curve the peak-to-peak amplitude of which defines the axial width L of the working layer between a first and a second axial end.

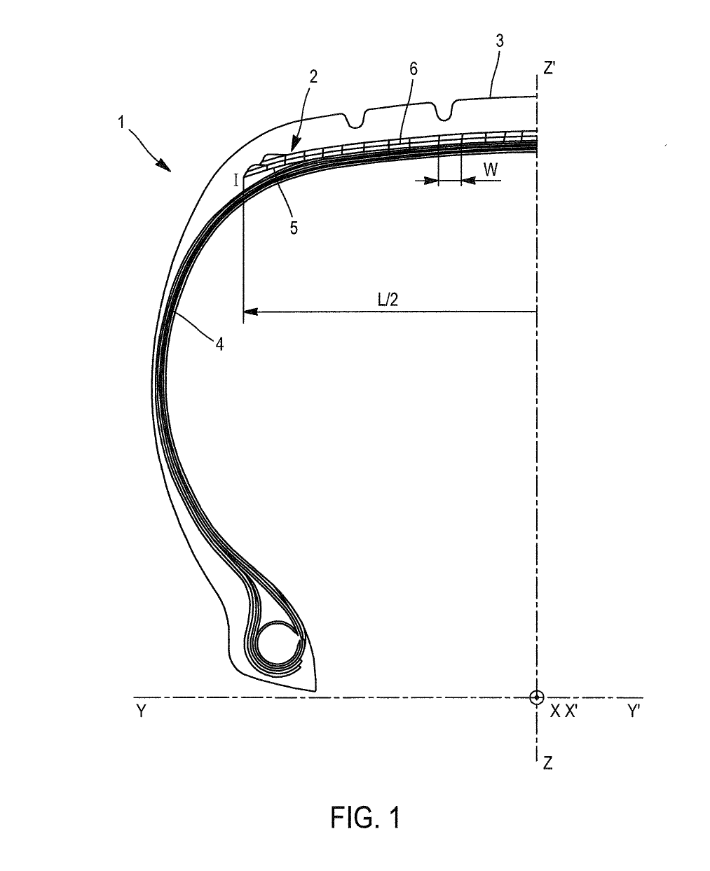

The features and other advantages of the invention will be better understood with the aid of FIGS. 1 to 5, which have not been drawn to scale:

FIG. 1: a half view in section of a reference tire, in a meridian or radial plane (YZ) passing through the axis of rotation (YY′) of the tire.

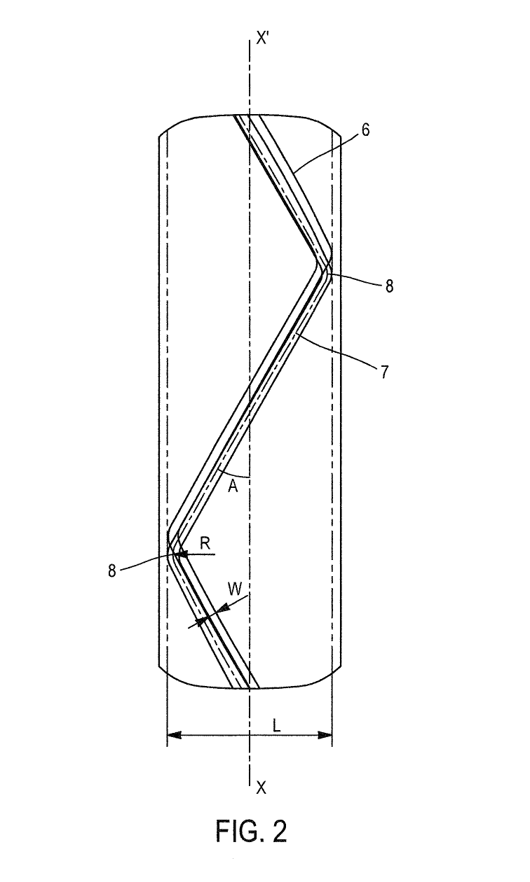

FIG. 2: a general arrangement of a strip that makes up a working layer of a reference tire.

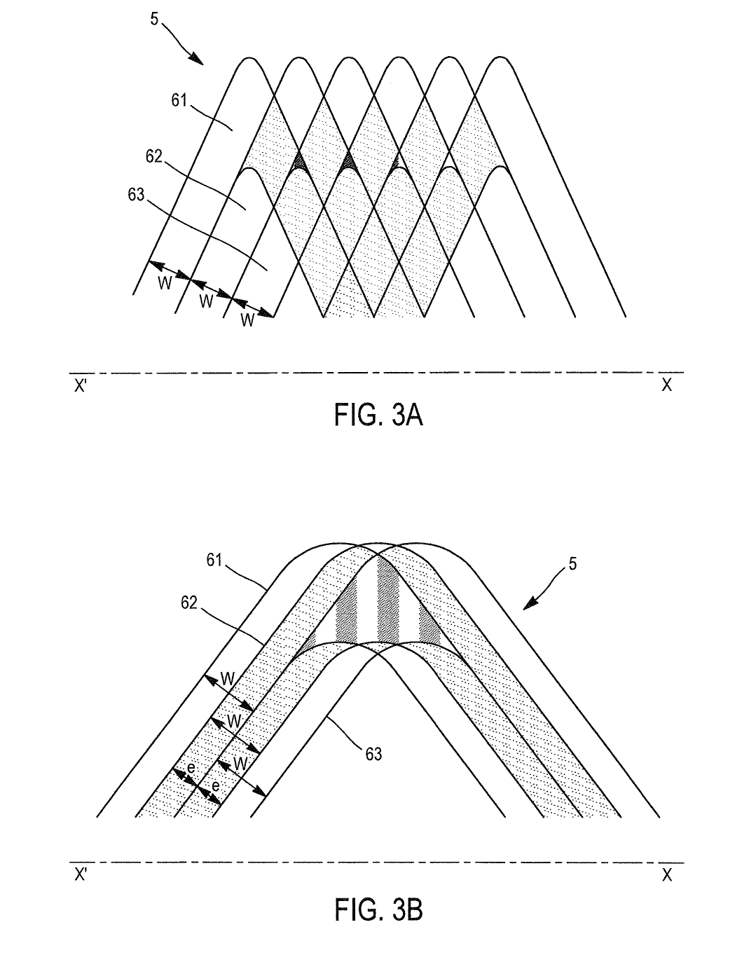

FIGS. 3A and 3B: plan views of an axial end of a working layer of a reference tire and of an axial end of a lapped working layer of a tire according to the invention, respectively.

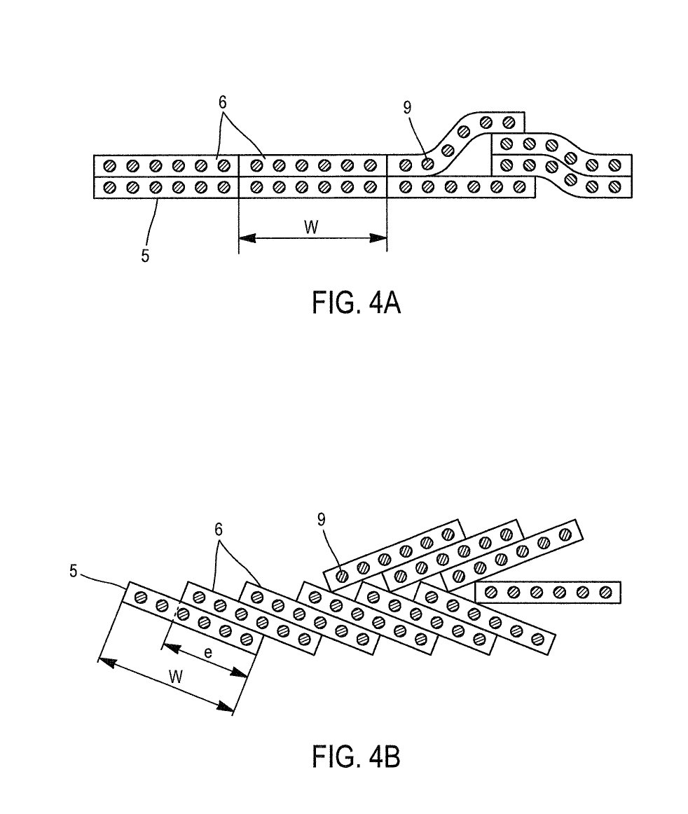

FIGS. 4A and 4B: views in section of an axial end of a working bi-ply of a reference tire and of an axial end of a lapped working layer of a tire according to the invention, respectively.

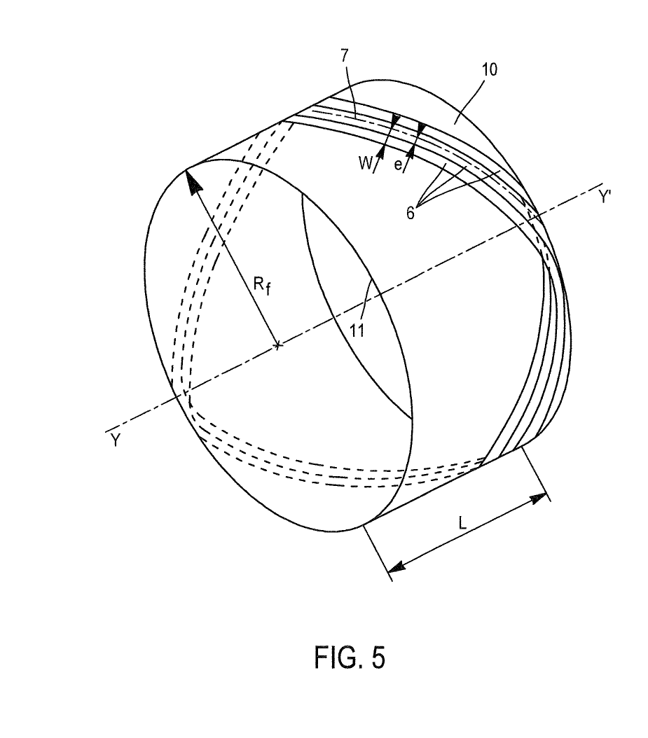

FIG. 5: a perspective view of a strip circumferentially wound in a zigzag with a periodic curve on the lateral surface of a building drum, in the case of a lapped working layer.

FIG. 1 depicts a half view in section, in a radial or meridian plane (YZ) passing through the axis of rotation (YY′) of the tire 1, of an aircraft tire 1 comprising a working reinforcement 2 radially on the inside of a tread 3 and radially on the outside of a carcass reinforcement 4. The working reinforcement 2 comprises at least two working layers 5 which are radially superposed and comprise, at each axial end (I), an axial end additional thickness comprising more than two radially superposed working layers. Each working layer 5 is characterized by its axial width L, comprised between a first axial end I and a second axial end I′ (not depicted) or by its half-width L/2, comprised between a first axial end I and the equatorial plane (XZ). Each working layer 5, in the case of a reference tire, is made up of an axial juxtaposition of strips 6 of width W.

FIG. 2 depicts a general arrangement of a strip 6 that makes up a working layer of axial width L, for a reference tire. FIG. 2 depicts a zigzag winding over two turns. The strip 6 of width W has a midline, running circumferentially, which means to say in the direction (XX′) along a periodic curve 7 comprising extrema 8. In other words, the periodic curve 7 is the curve supporting the midline of the strip 6. The periodic curve 7 in the equatorial plane (XZ) and with the circumferential direction (XX′) defines a non-zero angle A. The periodic curve 7 has a mean radius of curvature R at its extrema 8. For each turn of zigzag winding the strip 6 is axially offset so as to obtain an axial juxtaposition of portions of strip of width W.

FIG. 3A depicts a plan view of one axial end of a working layer 5 of a reference tire, which layer is made up of an axial juxtaposition of portions of strip (61, 62, 63) of width W. The white region corresponds to one thickness of strip, the pale grey region corresponds to two thicknesses of strip and the dark grey region corresponds to three thicknesses of strip.

FIG. 3B is a plan view of one axial end of a lapped working layer 5 of a tire according to the invention, which layer is made up of an arrangement of portions of strip (61, 62, 63) of width W which arrangement is such that two consecutive portions of strip (61, 62, 63) overlap, at least in part, over a width of overlap e. In the case depicted, the width of overlap e is equal to 0.5 times the width W.

FIG. 4A is a view in section, in a radial plane (YZ) of an axial end region of a working bi-ply of a reference tire, which is made up of two working layers 5 radially superposed in a main section and of four working layers at least partially superposed at the axial end additional thickness. Each working layer is made up of an axial juxtaposition of portions of strip 6 of width W. Each portion of strip 6 comprises textile reinforcers 9 coated in an elastomeric compound.

FIG. 4B is a view in section, in a radial plane (YZ) of an axial end region of a lapped working layer 5 of a tire according to the invention. In the main section, two consecutive portions of strip 6 of width W are superposed over a width of overlap e. In the case depicted, the width of overlap e is equal to 0.5 times the width W. At the axial end of the lapped working layer, the portions of strip 6 are arranged in a chevron configuration. Each portion of strip 6 comprises textile reinforcers 9 coated in an elastomeric compound.

FIG. 5 is a perspective view of a strip 6 wound circumferentially in a zigzag, with a periodic curve 7, on the lateral surface 10 of a building drum 11 of radius R_{f}, height L and having as axis of revolution the axis of rotation (YY′) of the tire. Two consecutive portions of strip 6 of width W are superposed over a width of overlap e.

The inventors carried out the invention for an aircraft tire of size 1400X530 R 23.

In the tire investigated, the strip that made up a lapped working layer has a width W of 11 mm, and two consecutive portions of strip are superposed over a width of overlap equal to 5.5 mm, giving an e/W ratio equal to 0.5. The working reinforcement of the tire according to the invention is made up, radially from the inside towards the outside, of a radial superposition of a zigzag-wound lapped working layer with a width of overlap equal to 5.5 mm, axial width of 390 mm, of a zigzag-wound working bi-ply of axial width 365 mm and of a working layer, wound in turns, with an axial width of 316 mm. The working reinforcement of the reference tire is made up, radially from the inside towards the outside, of a radial superposition of three zigzag wound working bi-plys, with respective axial widths of 390 mm, 365 and 345 mm and of a working layer, wound in turns, with an axial width of 316 mm. The gain in endurance of a tire comprising a lapped working layer according to the invention, as compared with the reference tire, leads to a gain in endurance estimated to be equal to at least 10%. This endurance is measured in terms of the amount of damage found on a tire subjected to a regulation TSO test as defined by the European Aviation European Safety Agency (EASA).

1. An aircraft tire comprising:
a working reinforcement radially on the inside of a tread and radially on the outside of a carcass reinforcement;
the working reinforcement comprising at least one working layer made up of a circumferential zigzag winding of a strip on a cylindrical surface having as its axis of revolution the axis of rotation of the tire, with a periodic curve, the peak-to-peak amplitude of which defines the axial width L of the working layer between a first and a second axial end;
the working layer being made up, in any meridian plane containing the axis of rotation of the tire, of an arrangement of portions of strip R extending axially from the first axial end to the second axial end of the working layer,
the strip of width W being made up of textile reinforcers coated in an elastomeric compound,
wherein, in any meridian plane containing the axis of rotation of the tire, the arrangement of portions of the strip extending axially from the first axial end to the second axial end of the working layer is such that two consecutive portions of the strip overlap, at least in part, over a width of overlap e, and wherein the width of overlap e between two consecutive portions of the strip is constant over the entire axial width L of the working layer.

2. The aircraft tire according to claim 1, wherein the width of overlap e between two consecutive portions of the strip is at least equal to 0.5 times and at most equal to 0.8 times the width W of the strip.

3. The aircraft tire according to claim 1, wherein the width of overlap e between two consecutive portions of the strip is equal to 0.5 times the width W of the strip.

4. The aircraft tire according to claim 1, wherein the width of overlap e between two consecutive portions of the strip is equal to 0.66 times the width W of the strip.

5. The aircraft tire according to claim 1, wherein the width W of the strip is at least equal to 2 mm.

6. The aircraft tire according to claim 1, wherein the width W of the strip is at most equal to 20 mm.

7. The aircraft tire according to claim 1, wherein the reinforcers of the working layer are made of an aliphatic polyamide.

8. The aircraft tire according to claim 1, wherein which the reinforcers of the working layer are made of an aromatic polyamide.

9. The aircraft tire according to claim 1, wherein the reinforcers of the working layer are made of a combination of an aliphatic polyamide and of an aromatic polyamide.

10. A method of manufacturing an aircraft tire according to claim 1, comprising a step of manufacturing a working layer in which step the working layer is obtained by circumferential zigzag winding of the strip of width W onto the lateral surface of a building drum of radius R_{f} and having as axis of revolution the axis of rotation of the tire, with a periodic curve the peak-to-peak amplitude of which defines the axial width L of the working layer between a first axial end and a second axial end.

11. The aircraft tire according to claim 1, wherein the width W of the strip is at least equal to 6 mm.

12. The aircraft tire according to claim 1, wherein the width W of the strip is at most equal to 14 mm.
